(19) United States
(12) Patent Application Publication
(10) Pub. No.: US 2004/0241548 A1
(43) Pub. Date: Dec. 2, 2004

(54) Negative electrode active material and non-aqueous electrolyte rechargeable battery using the same

(76) Inventors: Takayuki Nakamoto, Osaka (JP); Yasuhiko Bito, Osaka (JP)

Correspondence Address: MCDERMOTT, WILL & EMERY, 600 13th Street, N.W., WASHINGTON, DC, 20005-3096, US

(21) Appl. No.: 10/816,221

(22) Filed: Apr. 2, 2004

(30) Foreign Application Priority Data
Apr. 2, 2003 (JP) JP2003-099523

(51) Int. Cl. H01M 4/40

(52) U.S. Cl. 429/231.95

(57) ABSTRACT

The present invention provides a negative electrode active material for a non-aqueous electrolyte rechargeable battery capable of absorbing/desorbing lithium having: an inner layer including at least a material selected from the group consisting of Si, Sn, an alloy containing Si and an alloy containing Sn; and a surface layer including silicon oxide or tin oxide of 0.2 to 1,000 nm in average thickness formed on the inner layer. Use of the negative electrode active material allows obtaining a non-aqueous electrolyte rechargeable battery having high capacity, and excellent cycle life characteristic and high-temperature storage characteristic.

### BACKGROUND OF THE INVENTION

A lithium rechargeable battery has conventionally been used as a power source for mobile telecommunication equipment and portable electronic equipment. The lithium secondary battery exhibits higher electromotive force and higher energy density than alkaline storage batteries such as a nickel-cadmium storage battery and a nickel metal-hydride storage battery and utilizes lithium metal or graphite powder as a negative electrode material.

However, when the lithium metal is used as the negative electrode material of the lithium rechargeable battery, dendrites are deposited on the negative electrode in a charging state. The dendrites grow through repeated charge and discharge and penetrate a separator, which may possibly cause internal short circuit. Correspondingly, the cycle life may possibly decrease.

On the other hand, when the graphite powder is used as the negative electrode material of the lithium rechargeable battery, the battery capacity becomes smaller than the capacity of the battery using the lithium metal because the theoretical capacity of the graphite powder (372 mAh/g) is about 10% of that of elemental lithium metal. Therefore, the graphite powder is disadvantageous in that it cannot meet the growing demand for higher energy density.

Under these circumstances, in recent years, attempts have been made to use other materials having higher theoretical capacity as novel negative electrode materials, e.g., silicon (theoretical capacity: 993 mAh/g), tin (theoretical capacity: 4199 mAh/g) and an alloy containing these elements.

For example, Japanese Laid-Open Patent Publication No. HEI10-294112 discloses a negative electrode material represented by M_{1-x/100}Si_{x/100} (where M is Ni, Fe, Co or Mn and x (at %)≧50).

Further, the Publication also discloses how to produce the negative electrode material. First, M and Si are weighed to have a predetermined molar ratio (1−x/100):x/100 and melted by high-frequency induction melting process in atmospheric air to obtain a molten alloy. This molten alloy is quenched by a single roll process or the like for solidification to give an alloy mass of M_{1-x/100}Si_{x/100}. Then, the alloy mass is pulverized into fine powder using a jet mill to obtain alloy powder as the negative electrode material.

However, the inventors' analysis has found that the above material is high in capacity but unsatisfactory in cycle life characteristic. For example, according to a charge/discharge test of a battery similar to that of Example 3 of the above-mentioned Publication, the initial battery capacity was as high as about 1300 mAh/g. However, after the 100th charge/discharge cycle, the battery capacity was reduced to 30% of the capacity at the first cycle. Therefore, sufficient cycle life characteristic was not obtained.

A cause of the insufficient cycle life characteristic is considered as follows.

During the preparation of the molten alloy by high-frequency induction melting process in atmospheric air, oxygen becomes mixed therein to form a silicon oxide layer on the alloy surface. Since the resistivity of silicon oxide is as high as 10¹² Ω·M (“Latest Handbook of Oxide”, Moscow Metallurgy), Li ions are not smoothly adsorbed and desorbed to and from the alloy surface in a charge/discharge reaction. Thereby, the reaction resistance is prone to increase.

In fact, the presence of silicon oxide was actually observed on the alloy surface by X-ray photoelectron spectroscopy (XPS). An average thickness of the silicon oxide layer was 1,100 nm, which increased up to 1,300 nm after the 100^{th} cycle. The precise mechanism of the increase in thickness of the silicon oxide layer through the repeated charge and discharge is unknown. However, due to the presence of silicon oxide having high reaction resistance on the alloy surface, a side reaction is prone to occur between oxygen in the electrolyte and the alloy, as well as the electrochemical reaction between the alloy and the Li ions. For that reason, it is presumed that the silicon oxide layer increased in thickness through the repeated charge and discharge. Further, the increase in thickness of the silicon oxide layer brings about an increase in reaction resistance, which presumably results in the unsatisfactory cycle life characteristic.

And, except for the above alloy powders, for example, Japanese Laid-open Patent Publication No. 2002-83594 proposes to use a thin silicon film as a negative electrode to obtain high capacity and excellent cycle life characteristic. However, studies on the thickness of the surface oxide layer of thin silicon film are insufficient.

According to a close study on this matter, the inventors of the present invention have found it effective at solving the above problem to limit the thickness of the silicon oxide layer formed on the surface of the alloy powder and the thin film.

Thus, to solve the conventional problems described above, the present invention intends to provide a negative electrode active material for a non-aqueous electrolyte rechargeable battery which adsorbs a large amount of lithium and has reduced reaction resistance. Further, with use of the negative electrode active material, the present invention intends to provide a non-aqueous electrolyte rechargeable battery having high capacity, and excellent cycle life characteristic and high-temperature storage characteristic.

### BRIEF SUMMARY OF THE INVENTION

A negative electrode active material for a non-aqueous electrolyte rechargeable battery of the present invention is capable of adsorbing and desorbing lithium and comprises: an inner layer comprising at least a material selected from the group consisting of Si, Sn, an alloy containing Si and an alloy containing Sn; and a surface layer comprising silicon oxide or tin oxide of 0.2 to 1,000 nm in average thickness formed on the inner layer.

The average thickness of the surface layer is preferably 1 to 100 nm.

The average thickness of the surface layer is preferably 1 to 10 nm.

The surface layer preferably has a thickness in the range of ±50% of the average thickness.

The alloy preferably comprises Si or Sn and at least an element selected from the group consisting of Ti, Co, Ni, Cu, Mg, Zr, V, Mo, W, Mn and Fe.

The alloy preferably comprises at least an Si phase or an Sn phase and an alloy phase containing at least an element selected from the group consisting of Ti, Co, Ni, Cu, Mg, Zr, V, Mo, W, Mn and Fe.

The negative electrode active material is preferably in the form of a thin film or powder.

The negative electrode active material preferably includes an amorphous Si phase.

The present invention further relates to a non-aqueous electrolyte rechargeable battery using the above-described negative electrode active material.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic vertical section of a cylindrical lithium ion rechargeable battery according to Examples of the present invention.

### DETAILED DESCRIPTION OF THE INVENTION

The present invention relates to a negative electrode active material for a non-aqueous electrolyte rechargeable battery capable of adsorbing and desorbing lithium and comprises: an inner layer comprising at least a material selected from the group consisting of Si, Sn, an alloy containing Si and an alloy containing Sn; and a surface layer comprising silicon oxide or tin oxide of 0.2 to 1,000 nm in average thickness formed on the inner layer.

If the average thickness of the surface layer is 1,000 nm or smaller, the reaction resistance becomes low and its increase is inhibited even if the charge and discharge are repeated. Thereby, a favorable cycle life characteristic is obtained. On the other hand, if the average thickness of the surface layer is larger than 1,000 nm, the reaction resistance becomes high due to the too-large thickness of the surface layer. Accordingly, the cycle life characteristic becomes insufficient.

As a result of a close study on high-temperature storage characteristic, it has been found that the high-temperature storage characteristic is favorable when the average thickness is 0.2 nm or larger, but deteriorated when the average thickness is less than 0.2 nm. In this context, the favorable high-temperature storage characteristic means that a battery in a charged state exhibits high discharge capacity after being stored at high temperatures.

Though the precise mechanism is unknown, it is assumed that the surface layer prevents the alloy surface and the electrolyte from causing a side reaction between them which is prone to occur in a high temperature state. If the surface layer is too thin or does not exist, the side reaction cannot be prevented, thereby increasing the reaction resistance, decreasing the discharge capacity and deteriorating the high-temperature storage characteristic.

Therefore, the favorable cycle life characteristic and high-temperature storage characteristic are obtained when the average thickness of the silicon or tin oxide layer formed on the inner layer comprising at least a material selected from the group consisting of Si, Sn, an alloy containing Si and an alloy containing Sn is 0.2 to 1,000 nm.

The average thickness of the surface layer is preferably 1 to 100 nm because the cycle life characteristic and the high-temperature storage characteristic are further improved. More preferably, the average thickness of the surface layer is 1 to 10 nm because it allows further improvement in cycle life characteristic while keeping the satisfactory high-temperature storage characteristic.

The surface layer preferably has a thickness in the range of ±50% of the average thickness. The electrode reaction occurs uniformly, thereby improving the cycle life characteristic and the high-temperature storage characteristic.

It is preferable that the alloy containing Si or Sn includes Si or Sn, and at least an element selected from the group consisting of Ti, CO, Ni, Cu, Mg, Zr, V, Mo, W, Mn and Fe. With use of such an alloy, the negative electrode active material can be stabilized and prevented from pulverizing during the repeated charge and discharge. If the negative electrode active material is pulverized, the negative electrode active material decreases in reactivity and the cycle life is apt to decrease.

Further, if the ratio of the element to be alloyed with Si or Sn increases, the capacity of the resulting alloy decreases. Therefore, it is not preferable to use the element to be alloyed with Si or Sn in a larger ratio than is necessary.

The alloy containing Si or Sn preferably includes at least an Si phase or an Sn phase and an alloy phase containing at least an element selected from the group consisting of Ti, CO, Ni, Cu, Mg, Zr, V, Mo, W, Mn and Fe.

The use of such an alloy can prevent the negative electrode active material from pulverizing more effectively. Accordingly, further improvement in cycle life characteristic is expected.

The above-described negative electrode active material may be in either form of a thin film or powder.

The negative electrode active material in the form of a thin film may be formed by any method as long as the method forms a thin film. For example, vacuum deposition, chemical vapor deposition (CVD), sputtering, plating, thermal spraying and the like may be employed. The thin film is preferably 100 μm or smaller in thickness and may be dense or porous. Examples of the porous film include a film having columnar pores and a film comprising a layered structure including a plurality of layers stacked at a certain interval.

The negative electrode active material in the form of powder may be formed by any method as long as the method gives powder. For example, may be adopted a method of preparing an alloy mass first and then pulverizing the mass into powder and a method of directly preparing powder. Examples thereof include a method of preparing an alloy mass by a melting method and then pulverizing the mass with a stamp mill or ball mill, and a method of directly obtaining the powder by atomization or mechanical alloying. Other examples of the method for preparing the alloy mass include a roll quenching method and a rotational electrode method.

The above-described negative electrode active material preferably contains an amorphous Si phase. The amorphous Si phase is more effective in inhibiting the pulverizing of the negative electrode active material through the repeated charge and discharge than a crystalline Si phase, thereby improving the cycle life characteristic.

In this context, the amorphous Si phase means a phase in which a crystallite size is 30 nm or smaller. The crystalline size is calculated by Scherrer's formula from a half width of a peak at a diffraction angle (2θ) attributed to the crystalline plane of the Si phase in a wide angle X-ray diffraction pattern of Si. The amorphous Si phase includes an amorphous phase and a microcrystalline phase.

Hereinafter, the present invention is explained in detail by way of Examples. However, the invention is not limited thereto.

### EXAMPLES 1-12 AND COMPARATIVE EXAMPLES 1-9

(1) Preparation of Negative Electrode Active Material

In Examples 1-6 and Comparative Examples 1-4, alloys containing Si or Sn were synthesized in the following manner. Table 1 shows the compositions of the alloys.

TABLE 1

| | | Heat treatment conditions | | |
|---|---|---|---|---|
| | | Volume ratio | Temperature | |
| | Composition | (O₂:Ar) | (° C.) | Time (hr) |
| Example 1 | TiSi₃ | 0.5:99.5 | 300 | 1 |
| Example 2 | TiSi₃ | 10:90 | 700 | 1 |
| Example 3 | TiSi₃ | 0.01:99.99 | 100 | 1 |
| Example 4 | Ti₂Sn₃ | 0.5:99.5 | 150 | 1 |
| Example 5 | Ti₂Sn₃ | 10:90 | 200 | 1 |
| Example 6 | Ti₂Sn₃ | 0.01:99.99 | 100 | 1 |
| Comparative | TiSi₃ | Atmospheric air | 800 | 1 |
| Example 1 | | | | |
| Comparative | TiSi₃ | No heat | — | — |
| Example 2 | | treatment | | |
| Comparative | Ti₂Sn₃ | Atmospheric air | 220 | 1 |
| Example 3 | | | | |
| Comparative | Ti₂Sn₃ | No heat | — | — |
| Example 4 | | treatment | | |

First, certain elements in the form of mass, plate or particles were mixed in a given ratio, which was melted in an Ar atmosphere by high-frequency induction melting process. Then, the resulting alloy mass was pulverized with a stamp mill under the Ar atmosphere. The obtained alloy powder was shifted through a sieve of 45 micron mesh in the Ar atmosphere to obtain negative electrode active material powder having an average particle diameter of 28 μm.

Then, the negative electrode active material powder was subjected to heat treatment under the conditions of atmosphere, temperature and time varied as shown in Table 1. Thus, silicon or tin oxide surface layers having various thicknesses were formed on the surface of the negative electrode active material powder.

In Examples 7-12 and Comparative Examples 5-8, Si or Sn powder was treated in the following manner.

Si or Sn powder was immersed in an aqueous solution containing 1 wt % of hydrofluoric acid and 40 wt % of ammonium fluoride at room temperature for 5 minutes and then dried at 60° C. under vacuum. Then, the Si or Sn powder was subjected to heat treatment under the conditions of atmosphere, temperature and time varied as shown in Table 2. Thus, silicon or tin oxide surface layers having various thicknesses were formed on the surface of the Si or Sn powder.

TABLE 2

| | | Heat treatment conditions | | |
|---|---|---|---|---|
| | | | Temperature | Time |
| | Composition | Volume ratio (O₂:Ar) | (° C.) | (hr) |
| Example 7 | Si | 0.5:99.5 | 300 | 1 |
| Example 8 | Si | 10:90 | 700 | 1 |
| Example 9 | Si | 0.01:99.99 | 100 | 1 |
| Example 10 | Sn | 0.5:99.5 | 150 | 1 |
| Example 11 | Sn | 10:90 | 200 | 1 |
| Example 12 | Sn | 0.01:99.99 | 100 | 1 |
| Comparative | Si | Atmospheric | 800 | 1 |
| Example 5 | | air | | |
| Comparative | Si | No heat | — | — |
| Example 6 | | treatment | | |
| Comparative | Sn | Atmospheric | 220 | 1 |
| Example 7 | | air | | |
| Comparative | Sn | No heat | — | — |
| Example 8 | | treatment | | |

(2) Production of Negative Electrode

Using the negative electrode active materials formed in Examples 1-12 and Comparative Examples 1-8, negative electrodes were formed. Further, a comparative negative electrode was formed using graphite (Comparative Example 9).

Each of the negative electrode active material powders shown in Tables 1 and 2 was mixed with carbon powder as a conductive material and PVdF (polyvinylidene fluoride) as a binder in the ratio of 75:20:5 by weight to obtain a mixture. The mixture was dispersed in dehydrated N-methylpyrrolidinone to obtain slurry. This slurry was applied to an electrolytic copper foil serving as a negative electrode current collector, which was dried and then rolled to obtain a negative electrode. All the steps for manufacturing the negative electrode were carried out in an Ar atmosphere.

(3) Production of Positive Electrode

Lithium cobaltate (LiCoO₂) powder as a positive electrode active material, carbon powder as a conductive material and PVdF as a binder were mixed in the ratio of 85:10:5 by weight to obtain a mixture. This mixture was dispersed in dehydrated N-methylpyrrolidinone to obtain slurry. This slurry was applied to an aluminum foil serving as a positive electrode current collector, which was dried and then rolled to obtain a positive electrode.

(4) Fabrication of Lithium Ion Rechargeable Battery

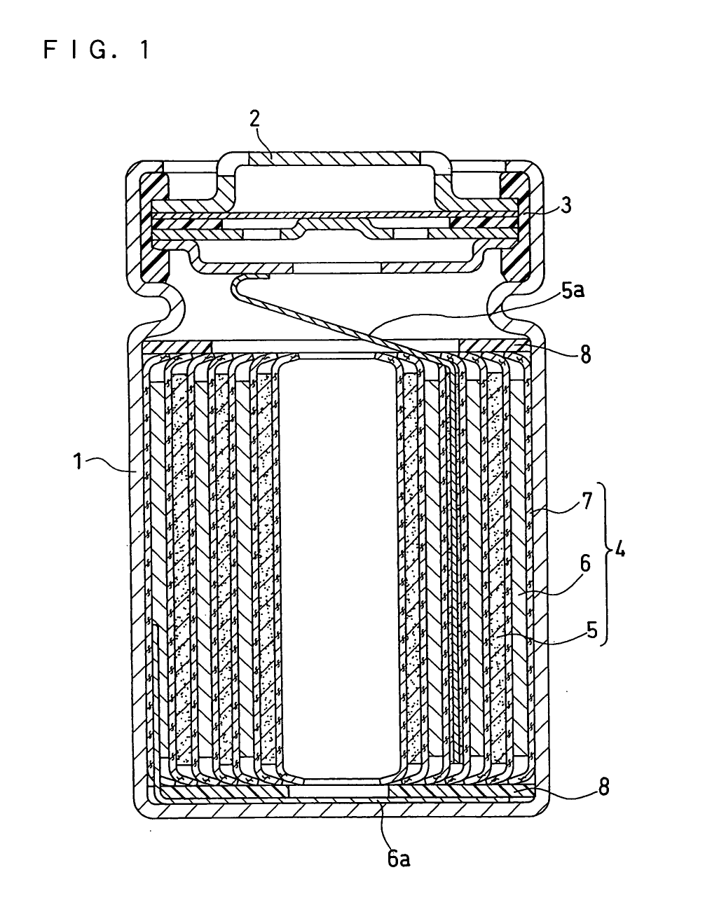

As a non-aqueous electrolyte rechargeable battery of the present invention, a cylindrical lithium ion rechargeable battery configured as shown in FIG. 1 was fabricated. FIG. 1 is a schematic vertical section of the cylindrical lithium ion rechargeable battery.

A positive electrode 5 and a negative electrode 6, which were obtained as described above, were stacked with a separator 7 interposed therebetween and rolled up to form an electrode assembly 4. Insulating rings 8 were attached to the top and the bottom of the electrode assembly 4, respectively. The positive electrode 5 was connected to a sealing plate 2 via a positive electrode lead 5a. The negative electrode 6 was connected to the bottom of a battery case (negative electrode can) 1 via a negative electrode lead 6a. Then, the electrode assembly 4 was placed in the battery case 1, in which a non-aqueous electrolyte was poured. The non-aqueous electrolyte used was a solvent mixture of ethylene carbonate and ethyl methyl carbonate in the volume ratio of 1:1 containing 1 mol/L of LiPF₆.

Then, the battery case 1 was sealed with the sealing plate 2 provided with a safe valve and an insulating packing 3. In this manner, batteries A1-A12 (using the negative electrode active materials of Examples 1-12) and batteries X1-X9 (using the negative electrode active materials of Comparative Example 1-9) were fabricated, each of which was a cylindrical sealed lithium ion rechargeable battery of 18 mm in diameter and 65 mm in height. The cylindrical lithium ion rechargeable batteries were fabricated in an Ar atmosphere having a dew point of −50° C. or lower.

[Evaluations]

(i) Qualitative Analysis and Thickness Measurement of Silicon or Tin Oxide Layer

Qualitative analysis of the silicon oxide layer was conducted using XPS-7000 manufactured by Rigaku Corporation. Al-Kα was used as an X-ray source. Narrow scan measurement was conducted under the conditions of a voltage of 10 kV, a current of 10 mA, an energy range of 114 to 94 eV and a step size of 0.08 eV. Si2p was used as the measurement element.

Further, the thickness of the silicon oxide layer was measured in the following manner.

The silicon oxide layer was subjected to Ar ion etching. At that time, where the integrated peak intensity ratio of silicon oxide to silicon was 50% or lower, the etch depth from the top surface of the silicon oxide layer was regarded as the thickness of the silicon oxide layer. The Ar ion etching was performed under the conditions of accelerated voltage of 500 V, etching angle of 90°, ion current density of 160 μA/cm² and the etching rate of 0.5-5 nm/minute in terms of SiO₂. The minimum etch depth was 0.2 nm. An average of thicknesses measured at five random points on the negative electrode active material powder was regarded as an average thickness.

As to the tin oxide layer, the qualitative analysis and thickness measurement were conducted in the same manner as the above. For the qualitative analysis of the tin oxide layer, narrow scan measurement was carried out under the conditions of an energy range of 504 to 476 eV and a step size of 0.08 eV using Sn3d as a measurement element. The thickness of the tin oxide layer was obtained as the etched depth from the top surface of the tin oxide layer when the integrated peak intensity ratio of tin oxide to tin was 50% or lower.

(ii) Cycle Life Test

Each of the batteries was subjected to repeated charge/discharge cycles. The charge was performed at 0.6 A up to 4.2 V at 20° C. and then the discharge was performed at 0.4 A down to 2.5 V at 20° C. At that time, discharge capacity C1 at the first cycle and discharge capacity C2 at the 100^{th} cycle were measured. With respect to every battery, the ratio P (%) of discharge capacity C2 to discharge capacity C1 was calculated from the formula shown below to evaluate the cycle life characteristic. The cycle life characteristic was judged as satisfactory when the value P was 85% or higher.

P(%)=(C2/C1)×100

(iii) Measurement of Internal Resistance of Battery

Internal resistance of the battery at a frequency of 1 kHz was measured by an A/C impedance method. The measurement was performed after discharge at the first cycle and the 100^{th} cycle of the above-described charge/discharge cycles.

(iv) High-Temperature Storage Test

After five charge/discharge cycles performed in the above-mentioned manner, discharge capacity C3 at the 5^{th} cycle was measured. Then, after the 6^{th} cycle charge, the battery was stored in a chamber at 80° C. for 3 days. After the storage period, the battery was discharged at 0.4 A down to 2.5 V at 20° C. to obtain discharge capacity C4. The ratio Q (%) of discharge capacity C4 to discharge capacity C3 was calculated by the following formula to evaluate the high-temperature storage characteristic of the battery. The high-temperature storage characteristic was judged as satisfactory when the value Q was 85% or higher.

Q(%)=(C4/C3)×100

Table 3 shows the evaluation results.

TABLE 3

| | | Average | | | | | | | | |
|---|---|---|---|---|---|---|---|---|---|---|
| | | thickness | | | | | | | Internal | |
| | | of | Discharge | | | Discharge | | | resistance | |
| | | surface | capacity | | | capacity | | | (mΩ) | |
| | Battery | layer | (mAh) | | Ratio | (mAh) | | Ratio | First | 100^{th} |
| | number | (nm) | C1 | C2 | P(%) | C3 | C4 | Q(%) | cycle | cycle |
| Ex. 1 | A1 | 100 | 2780 | 2634 | 94.7 | 2773 | 2522 | 91.0 | 40 | 44 |
| Ex. 2 | A2 | 1000 | 2755 | 2476 | 89.9 | 2741 | 2526 | 92.2 | 43 | 48 |
| Ex. 3 | A3 | 0.2 | 2793 | 2687 | 96.2 | 2788 | 2432 | 87.2 | 36 | 39 |
| Ex. 4 | A4 | 100 | 2770 | 2619 | 94.5 | 2762 | 2472 | 89.5 | 41 | 45 |
| Ex. 5 | A5 | 1000 | 2745 | 2465 | 89.8 | 2731 | 2511 | 91.9 | 44 | 49 |
| Ex. 6 | A6 | 0.2 | 2783 | 2640 | 94.9 | 2776 | 2407 | 86.7 | 37 | 40 |
| Ex. 7 | A7 | 100 | 2926 | 2508 | 85.7 | 2905 | 2500 | 86.1 | 42 | 47 |
| Ex. 8 | A8 | 1000 | 2910 | 2488 | 85.5 | 2889 | 2510 | 86.9 | 45 | 51 |
| Ex. 9 | A9 | 0.2 | 2942 | 2530 | 86.0 | 2921 | 2486 | 85.1 | 38 | 42 |
| Ex. 10 | A10 | 100 | 2916 | 2493 | 85.5 | 2895 | 2485 | 85.8 | 43 | 48 |
| Ex. 11 | A11 | 1000 | 2900 | 2473 | 85.3 | 2879 | 2495 | 86.7 | 46 | 52 |
| Ex. 12 | A12 | 0.2 | 2932 | 2515 | 85.8 | 2911 | 2475 | 85.0 | 39 | 43 |
| Com. | X1 | 1100 | 2711 | 2133 | 78.7 | 2682 | 2480 | 92.5 | 80 | 125 |
| Ex. 1 | | | | | | | | | | |
| Com. | X2 | <0.2 | 2805 | 2690 | 95.9 | 2799 | 1500 | 53.6 | 35 | 39 |
| Ex. 2 | | | | | | | | | | |
| Com. | X3 | 1100 | 2701 | 2101 | 77.8 | 2671 | 2458 | 92.0 | 82 | 130 |
| Ex. 3 | | | | | | | | | | |
| Com. | X4 | <0.2 | 2795 | 2646 | 94.7 | 2788 | 1485 | 53.3 | 37 | 41 |
| Ex. 4 | | | | | | | | | | |
| Com. | X5 | 1100 | 2895 | 1950 | 67.4 | 2848 | 2489 | 87.4 | 85 | 135 |
| Ex. 5 | | | | | | | | | | |
| Com. | X6 | <0.2 | 2950 | 2531 | 85.8 | 2929 | 1453 | 49.6 | 37 | 41 |
| Ex. 6 | | | | | | | | | | |
| Com. | X7 | 1100 | 2890 | 1942 | 67.2 | 2843 | 2476 | 87.1 | 86 | 138 |
| Ex. 7 | | | | | | | | | | |
| Com. | X8 | <0.2 | 2940 | 2513 | 85.5 | 2919 | 1429 | 49.0 | 38 | 42 |
| Ex. 8 | | | | | | | | | | |
| Com. | X9 | — | 2000 | 1870 | 93.5 | 1994 | 1800 | 90.3 | 40 | 43 |
| Ex. 9 | | | | | | | | | | |

The batteries A1-A12 each using the negative electrode active materials of Examples 1-12 showed higher capacity than that of the battery X9 of Comparative Example 9. Further, the cycle life characteristic and the high-temperature storage characteristic were as excellent as those of the battery X9.

The average thickness of the silicon or tin oxide layer on the negative electrode active material surface was 100 nm in Examples 1, 4, 7 and 10, 1,000 nm in Examples 2, 5, 8 and 11 and 0.2 nm in Examples 3, 6, 9 and 12.

The batteries A1-A12 using these negative electrode active materials showed the ratio P of 85.3-96.2%, indicating that these batteries were favorable in cycle life characteristic. Further, the ratio Q was 85.0-92.2%, showing that these batteries were excellent in high-temperature storage characteristic.

The batteries A1-A12 showed the internal resistance of 36-46 mΩ at the first cycle, which was not so high. After the 100^{th} cycle, the internal resistance increased by 3-5 mΩ, i.e., the increase in internal resistance through the charge/discharge cycles was hardly observed. Accordingly, it was found that the initial reaction resistance was low when the average thickness of the silicon or tin oxide layer was 1,000 nm or smaller and the reaction resistance was prevented from increasing through the repeated charge and discharge. Thus, satisfactory cycle life characteristic was given.

On the other hand, in Comparative Example 1, the average thickness of the silicon oxide layer on the alloy powder surface was 1,100 nm. Further, the internal resistance at the first cycle of the battery X1 of Comparative Example 1 was 80 mΩ, which was higher than that of the batteries A1-A12 of Examples 1-12. After the 100th cycle, the internal resistance was 125 mΩ, which was higher than the initial internal resistance by 45 mΩ.

In view of these results, it was proved that the average thickness of the silicon oxide layer larger than 1,000 nm increases the reaction resistance due to the too-large thickness, thereby increasing the internal resistance. The ratio P of the battery X1 was 78.7%, leading to unsatisfactory cycle life characteristic. The batteries X3, X5 and X7 of Comparative Example 3, 5 and 7 also showed insufficient cycle life characteristic for the same reason applied to the battery X1 of Comparative Example 1.

Regarding the battery X2 of Comparative Example 2, the integrated peak intensity ratio of silicon oxide to silicon was 20% or lower when the silicon oxide layer was etched by 0.2 nm. Therefore, the thickness of the silicon oxide layer on the alloy surface was estimated as less than 0.2 nm. Thus, the reaction resistance derived from the silicon oxide layer was almost zero and the ratio P was 95.9%, indicating that the cycle life characteristic was excellent. However, the ratio Q was 53.6%, showing that the high-temperature storage characteristic was unsatisfactory.

Though the precise mechanism is unknown, it is assumed that the silicon or tin oxide layer inhibits a side reaction between the alloy surface and the electrolyte, which occurs vigorously in a high temperature state. Therefore, if the silicon or tin oxide layer is too thin or does not exist, the side reaction cannot be inhibited. Accordingly, the reaction resistance increases, discharge capacity is apt to decrease and the high-temperature storage characteristic is impaired. The batteries X4, X6 and X8 of Comparative Examples 4, 6 and 8 showed unsatisfactory high-temperature storage characteristic for the same reason applied to the battery of Comparative Example 2.

### EXAMPLES 13-34

Alloys shown in Table 4 were prepared in a powder form by combining Si and at least an element selected from the group consisting of CO, Ni, Cu, Mg, Zr, V, Mo, W, Mn and Fe in the same manner as Example 1 (Examples 13-23). Further, alloys shown in Table 4 were prepared in a powder form by combining Sn and at least an element selected from the group consisting of CO, Ni, Cu, Mg, Zr, V, Mo, W, Mn and Fe (Examples 24-34).

Batteries A13-A34 were fabricated in the same manner as Example 1 except that the thus obtained alloy powders were used as the negative electrode active materials, respectively. The negative electrode active materials and batteries were evaluated in the same manner as Example 1. Table 4 shows the evaluation results.

TABLE 4

| | | | | | | | | | | Internal | |
|---|---|---|---|---|---|---|---|---|---|---|---|
| | | | Average | Discharge | | | Discharge | | | resistance | |
| | | | thickness | capacity | | | capacity | | | (mΩ) | |
| | Battery | | of surface | (mAh) | | Ratio | (mAh) | | Ratio | First | 100^{th} |
| | number | Composition | layer (nm) | C1 | C2 | P(%) | C3 | C4 | Q(%) | cycle | cycle |
| Ex. 13 | A13 | CoSi₃ | 100 | 2780 | 2615 | 94.1 | 2772 | 2510 | 90.6 | 41 | 45 |
| Ex. 14 | A14 | NiSi₃ | 100 | 2771 | 2609 | 94.2 | 2763 | 2500 | 90.5 | 41 | 45 |
| Ex. 15 | A15 | CuSi | 100 | 2766 | 2595 | 93.8 | 2757 | 2485 | 90.1 | 42 | 46 |
| Ex. 16 | A16 | MgSi | 100 | 2765 | 2600 | 94.0 | 2757 | 2491 | 90.4 | 41 | 45 |
| Ex. 17 | A17 | ZrSi₃ | 100 | 2770 | 2609 | 94.2 | 2762 | 2502 | 90.6 | 41 | 45 |
| Ex. 18 | A18 | VSi₃ | 100 | 2771 | 2590 | 93.5 | 2762 | 2500 | 90.5 | 43 | 47 |
| Ex. 19 | A19 | MoSi₃ | 100 | 2778 | 2601 | 93.6 | 2769 | 2500 | 90.3 | 43 | 47 |
| Ex. 20 | A20 | WSi₃ | 100 | 2777 | 2602 | 93.7 | 2768 | 2499 | 90.3 | 42 | 46 |
| Ex. 21 | A21 | MnSi₃ | 100 | 2772 | 2603 | 93.9 | 2764 | 2498 | 90.4 | 42 | 46 |
| Ex. 22 | A22 | FeSi₃ | 100 | 2773 | 2600 | 93.8 | 2764 | 2495 | 90.3 | 42 | 46 |
| Ex. 23 | A23 | Co_{0.5}Ni_{0.5}Si₃ | 100 | 2772 | 2608 | 94.1 | 2764 | 2505 | 90.6 | 41 | 45 |
| Ex. 24 | A24 | CoSn₃ | 100 | 2770 | 2605 | 94.0 | 2762 | 2465 | 89.3 | 42 | 46 |
| Ex. 25 | A25 | NiSn₃ | 100 | 2761 | 2599 | 94.1 | 2753 | 2455 | 89.2 | 42 | 46 |
| Ex. 26 | A26 | Cu₂Sn₃ | 100 | 2755 | 2585 | 93.8 | 2747 | 2440 | 88.8 | 43 | 47 |
| Ex. 27 | A27 | MgSn | 100 | 2755 | 2590 | 94.0 | 2747 | 2449 | 89.2 | 42 | 46 |
| Ex. 28 | A28 | ZrSn₃ | 100 | 2760 | 2599 | 94.2 | 2752 | 2457 | 89.3 | 42 | 46 |
| Ex. 29 | A29 | VSn₃ | 100 | 2761 | 2580 | 93.4 | 2752 | 2455 | 89.2 | 44 | 48 |
| Ex. 30 | A30 | MoSn₃ | 100 | 2768 | 2591 | 93.6 | 2759 | 2454 | 88.9 | 44 | 48 |
| Ex. 31 | A31 | WSn₃ | 100 | 2767 | 2592 | 93.7 | 2758 | 2453 | 88.9 | 43 | 47 |
| Ex. 32 | A32 | MnSn₃ | 100 | 2762 | 2593 | 93.9 | 2754 | 2455 | 89.2 | 43 | 47 |
| Ex. 33 | A33 | FeSn₃ | 100 | 2763 | 2590 | 93.7 | 2754 | 2450 | 89.0 | 43 | 47 |
| Ex. 34 | A34 | Co_{0.5}Ni_{0.5}Sn₃ | 100 | 2762 | 2598 | 94.1 | 2754 | 2460 | 89.3 | 42 | 46 |

The batteries A13-A34 showed higher capacity than the battery X9 of Comparative Example 9. Further, the cycle life characteristic and the high-temperature storage characteristic were as excellent as those of the battery X9. The batteries A13-A34 showed the ratio P of 93.4-94.2%, indicating that these batteries were satisfactory in cycle life characteristic. Further, the ratio Q was 88.8-90.6%, showing that these batteries were excellent in high-temperature storage characteristic. In these batteries, the average thickness of the silicon or tin oxide layer on the alloy powder surface was 0.2-1,000 nm.

### EXAMPLES 35-38

Alloys having the compositions shown in Table 5 were prepared in the following manner.

First, certain elements in the form of mass, plate or particles were mixed in a given ratio, which was melted in an Ar atmosphere by high-frequency induction melting process. Then, the mixture was cooled in the Ar atmosphere by atomization to prepare spherical alloy powder as a negative electrode active material. The alloy powder was shifted through a sieve of 45 micron mesh to obtain alloy powder having an average particle diameter of 28 μm. The alloy powders of Examples 35 and 37 were subjected to heat treatment under the same conditions as Example 1. The alloy powders of Examples 36 and 38 were subjected to heat treatment under the same conditions as Example 4.

According to measurement by wide angle X-ray diffraction of the resulting alloy powders, the alloy powder of Example 35 included two phases of an Si phase and a TiSi₂ phase, while that of Example 36 included two phases of an Sn phase and a Ti₆Sn₅ phase.

Batteries A35-A38 were fabricated in the same manner as Example 1 except that the thus obtained alloy powders were used as the negative electrode active materials, respectively. The negative electrode active materials and batteries were evaluated in the same manner as Example 1. Table 5 shows the evaluation results.

TABLE 5

| | | | | | | | | | | | Internal | |
|---|---|---|---|---|---|---|---|---|---|---|---|---|
| | | | | Average | Discharge | | | Discharge | | | resistance | |
| | | | | thickness | capacity | | | capacity | | | (mΩ) | |
| | Battery | | Alloy | of surface | (mAh) | | Ratio | (mAh) | | Ratio | First | 100^{th} |
| | number | Composition | phase | layer (nm) | C1 | C2 | P(%) | C3 | C4 | Q(%) | cycle | cycle |
| Ex. 35 | A35 | TiSi₃ | Si + TiSi₂ | 100 | 2780 | 2655 | 95.5 | 2774 | 2530 | 91.2 | 40 | 43 |
| Ex. 36 | A36 | Ti₂Sn₃ | Sn + Ti₆Sn₅ | 100 | 2770 | 2643 | 95.4 | 2764 | 2473 | 89.5 | 41 | 44 |
| Ex. 37 | A37 | TiSi₂ | TiSi₂ | 100 | 2605 | 2381 | 91.4 | 2594 | 2366 | 91.2 | 40 | 44 |
| Ex. 38 | A38 | Ti₆Sn₅ | Ti₆Sn₅ | 100 | 2600 | 2377 | 91.4 | 2589 | 2319 | 89.6 | 41 | 45 |

The batteries A37 and A38 each using the single-phase alloys of Examples 37 and 38 as the negative electrode active materials showed excellent cycle life characteristic and high-temperature storage characteristic. The batteries A35 and A36 each using the two-phase alloys of Examples 35 and 36 as the negative electrode active materials showed superior cycle life characteristic to those of the batteries A37 and A38.

### EXAMPLES 39-45

According to various methods as described below, thin Si films were formed.

According to vacuum deposition, an Si mass was evaporated using an electron beam under vacuum of about 0.00003 Torr to form a thin Si film on an electrolytic copper foil (Example 39).

According to chemical vapor deposition (CVD), silane was used as a source gas and hydrogen was used as a carrier gas. Then, a thin Si film was formed on an electrolytic copper foil under vacuum of 0.3 Torr while heating the electrolytic copper foil at 200° C. (Example 40).

Further, a thin Si film was formed by sputtering on an electrolytic copper film under vacuum of 0.1 Torr and high frequency power of 200 W (Example 41).

The thus obtained thin Si films were subjected to heat treatment in an atmosphere of oxygen and Ar mixed in the volume ratio of 0.5:99.5 at 300° C. for an hour.

Further, a thin TiSi₂ alloy film was formed by vacuum deposition as described below (Example 43).

Masses of Si and Ti were evaporated under vacuum of about 0.00003 Torr using an electron beam to form a thin TiSi₂ alloy film on an electrolytic copper foil. The thin TiSi₂ alloy film was subjected to heat treatment in an atmosphere of oxygen and Ar mixed in the volume ratio of 0.5:99.5 at 300° C. for an hour.

A thin Sn film was formed by electroless plating as described below (Example 42).

A plating solution was prepared by dissolving 0.1 mol/L of SnSO₄ in a 0.1 mol/L H₂SO₄ aqueous solution. In 100 ml of the plating solution, an electrolytic copper foil was immersed at a bath temperature of 40° C. for 15 minutes to form a thin Sn film thereon. Then, the thin Sn film was subjected to heat treatment in an atmosphere of oxygen and Ar mixed in the volume ratio of 0.5:99.5 at 150° C. for an hour.

A thin CoSn alloy film was formed by electroless plating as described below (Example 44).

A plating solution was prepared by dissolving 0.1 mol/L of SnSO₄ and 0.1 mol/L of CoSO₄ in a 0.1 mol/L H₂SO₄ aqueous solution. In 100 ml of the plating solution, an electrolytic copper foil was immersed at a bath temperature of 40° C. for 15 minutes to form a thin CoSn alloy film thereon. Then, the thin alloy film was subjected to heat treatment in an atmosphere of oxygen and Ar mixed in the volume ratio of 0.5:99.5 at 150% for an hour.

A thin film comprising a crystalline Si phase was formed in the following manner (Example 45).

A thin Si film was formed in the same manner as Example 40, which was subjected to heat treatment in an Ar atmosphere at 800° C. for an hour. Further, the thin Si film was subjected to another heat treatment in an atmosphere of oxygen and Ar mixed in the volume ratio of 0.5:99.5 at 300° C. for an hour. The thin Si film had a crystallite size of 40 nm, which was calculated by Scherrer's formula from half width of a peak at a diffraction angle (2θ) attributed to the crystalline plane of the Si phase in a wide angle X-ray diffraction pattern of Si. Therefore, it was confirmed that the thin film includes the crystalline Si phase.

All the thin films obtained in the above Examples had a dense structure.

Batteries A39-A45 were fabricated in the same manner as Example 1 except that the negative electrode active materials formed as the thin films on the copper foils were used as the negative electrodes, respectively. The negative electrode active materials and batteries were evaluated in the same manner as Example 1. Further, an average of thicknesses measured at five random points on the thin film was regarded as the average thickness of the silicon or tin oxide layer formed on the thin film. Table 6 shows the evaluation results.

TABLE 6

| | | | | | | | | | | Internal | |
|---|---|---|---|---|---|---|---|---|---|---|---|
| | | | Average | Discharge | | | Discharge | | | resistance | |
| | | | thickness | capacity | | | capacity | | | (mΩ) | |
| | Battery | | of surface | (mAh) | | Ratio | (mAh) | | Ratio | First | 100^{th} |
| | number | Composition | layer (nm) | C1 | C2 | P(%) | C3 | C4 | Q(%) | cycle | cycle |
| Ex. 39 | A39 | Si | 100 | 2930 | 2670 | 91.1 | 2917 | 2585 | 88.6 | 41 | 45 |
| Ex. 40 | A40 | Si | 100 | 2932 | 2667 | 91.0 | 2919 | 2578 | 88.3 | 41 | 45 |
| Ex. 41 | A41 | Si | 100 | 2935 | 2672 | 91.0 | 2922 | 2590 | 88.6 | 41 | 45 |
| Ex. 42 | A42 | Sn | 100 | 2950 | 2521 | 85.5 | 2929 | 2506 | 85.6 | 43 | 48 |
| Ex. 43 | A43 | TiSi₂ | 100 | 2600 | 2390 | 91.9 | 2590 | 2321 | 89.6 | 40 | 44 |
| Ex. 44 | A44 | CoSn | 100 | 2450 | 2214 | 90.4 | 2438 | 2192 | 89.9 | 41 | 45 |
| Ex. 45 | A45 | Si | 100 | 2930 | 2530 | 86.3 | 2910 | 2545 | 87.5 | 42 | 47 |

The batteries A39-A45 of Examples 39-45 showed higher capacity than the battery X9 of Comparative Example 9. Further, the cycle life characteristic and the high-temperature storage characteristic were as excellent as those of the battery X9. The batteries A39-A45 showed the ratio P of 85.5-91.9%, indicating that these batteries were satisfactory in cycle life characteristic. Further, the ratio Q was 85.6-89.9%, showing that these batteries were satisfactory in high-temperature storage characteristic.

According to wide angle X-ray diffraction measurement, the thin Si film of Example 40 had the crystallite size of 10 nm and included an amorphous Si phase. In comparison with the thin film of Example 45 comprising a crystalline Si phase, the battery A40 of Example 40 showed the ratio P of 91.0%, which was higher than the ratio P of the battery A45 (86.3%) as shown in Table 4, indicating that excellent cycle life characteristic was obtained.

It is assumed that the amorphous Si phase is more effective than the crystalline Si phase in inhibiting the crush of the negative electrode active material into fine particles through the repeated charge and discharge.

### EXAMPLES 46-49

A TiSi₃ alloy prepared in the same manner as Example 1 was subjected to heat treatment under the conditions shown in Table 7 to form surface layers having various thicknesses.

TABLE 7

Heat treatment conditions

| | Volume ratio | Temperature | Time |
|---|---|---|---|
| | (O₂:Ar) | (° C.) | (hr) |
| Example 46 | 5:95 | 500 | 1 |
| Example 47 | 0.3:99.7 | 250 | 1 |
| Example 48 | 0.1:99.9 | 200 | 1 |
| Example 49 | 0.05:99.95 | 150 | 1 |

Batteries A46-A49 were fabricated in the same manner as Example 1 except that the alloy powders obtained in the above were used as the negative electrode active materials, respectively. The negative electrode active materials and batteries were evaluated in the same manner as Example 1. Table 8 shows the evaluation results together with those of the batteries of Examples 1-3 and Comparative Examples 1 and 2.

TABLE 8

| | | | | | | | | | | Internal | |
|---|---|---|---|---|---|---|---|---|---|---|---|
| | | | Average | Discharge | | | Discharge | | | resistance | |
| | | | thickness | capacity | | | capacity | | | (mΩ) | |
| | Battery | | of surface | (mAh) | | Ratio | (mAh) | | Ratio | First | 100^{th} |
| | number | Composition | layer (nm) | C1 | C2 | P(%) | C3 | C4 | Q(%) | cycle | cycle |
| Comparative | X1 | TiSi₃ | 1100 | 2711 | 2133 | 78.7 | 2682 | 2480 | 92.5 | 80 | 125 |
| Example 1 | | | | | | | | | | | |
| Example 2 | A2 | TiSi₃ | 1000 | 2755 | 2476 | 89.9 | 2741 | 2526 | 92.2 | 43 | 48 |
| Example 46 | A46 | TiSi₃ | 500 | 2770 | 2547 | 91.9 | 2759 | 2515 | 91.2 | 42 | 47 |
| Example 1 | A1 | TiSi₃ | 100 | 2780 | 2634 | 94.7 | 2773 | 2522 | 91.0 | 40 | 44 |
| Example 47 | A47 | TiSi₃ | 50 | 2785 | 2643 | 94.9 | 2778 | 2527 | 91.0 | 39 | 43 |
| Example 48 | A48 | TiSi₃ | 10 | 2788 | 2678 | 96.1 | 2783 | 2528 | 90.9 | 38 | 41 |
| Example 49 | A49 | TiSi₃ | 1 | 2790 | 2682 | 96.1 | 2785 | 2513 | 90.2 | 37 | 40 |
| Example 3 | A3 | TiSi₃ | 0.2 | 2793 | 2687 | 96.2 | 2788 | 2432 | 87.2 | 36 | 39 |
| Comparative | X2 | TiSi₃ | 0 | 2805 | 2690 | 95.9 | 2799 | 1500 | 53.6 | 35 | 38 |
| Example 2 | | | | | | | | | | | |

Each of the batteries showed excellent cycle life characteristic and high-temperature storage characteristic when the average thickness of the silicon or tin oxide layer on the alloy powder surface was in the range of 0.2 to 1,000 nm. When the average thickness was 1 nm or larger, the high-temperature storage characteristic was further improved. Further, when the average thickness was 100 nm or smaller, the cycle life characteristic was more improved. These results indicated that the average thickness of the silicon or tin oxide layer on the alloy surface was preferably 1 to 100 nm.

More preferably, the average thickness of the silicon or tin oxide layer on the alloy powder surface was 1 to 10 nm. In this case, the cycle life characteristic was further improved while keeping satisfactory high-temperature storage characteristic.

### EXAMPLES 50-55 AND COMPARATIVE EXAMPLES 10-11

A thin Si film prepared in the same manner as Example 39 was subjected to heat treatment under the conditions shown in Table 9 to form surface layers having various thicknesses.

TABLE 9

Heat treatment conditions

| | Volume ratio | Temperature | Time |
|---|---|---|---|
| | (O₂:Ar) | (° C.) | (hr) |
| Example 50 | 10:90 | 700 | 1 |
| Example 51 | 5:95 | 500 | 1 |
| Example 52 | 0.3:99.7 | 250 | 1 |
| Example 53 | 0.1:99.9 | 200 | 1 |
| Example 54 | 0.05:99.95 | 150 | 1 |
| Example 55 | 0.01:99.99 | 100 | 1 |
| Comparative | Atmospheric air | 800 | 1 |
| Example 10 | | | |
| Comparative | No heat treatment | — | — |
| Example 11 | | | |

Batteries A50-A55 and X10-X11 were fabricated in the same manner as Example 1 except that the negative electrode active materials formed as the thin films obtained in the above were used as the negative electrodes, respectively. The negative electrode active materials and batteries were evaluated in the same manner as Example 1. Table 10 shows the evaluation results together with those of the battery of Example 39.

TABLE 10

| | | | | | | | | | | Internal | |
|---|---|---|---|---|---|---|---|---|---|---|---|
| | | | Average | Discharge | | | Discharge | | | resistance | |
| | | | thickness | capacity | | | capacity | | | (mΩ) | |
| | Battery | | of surface | (mAh) | | Ratio | (mAh) | | Ratio | First | 100^{th} |
| | number | Composition | layer (nm) | C1 | C2 | P(%) | C3 | C4 | Q(%) | cycle | cycle |
| Comparative | X10 | Si | 1100 | 2873 | 2438 | 84.9 | 2851 | 2567 | 90.0 | 80 | 125 |
| Example 10 | | | | | | | | | | | |
| Example 50 | A50 | Si | 1000 | 2905 | 2536 | 87.3 | 2887 | 2588 | 89.7 | 44 | 49 |
| Example 51 | A51 | Si | 500 | 2920 | 2580 | 88.4 | 2903 | 2580 | 88.9 | 43 | 48 |
| Example 39 | A39 | Si | 100 | 2930 | 2670 | 91.1 | 2917 | 2585 | 88.6 | 41 | 45 |
| Example 52 | A52 | Si | 50 | 2936 | 2683 | 91.4 | 2923 | 2587 | 88.5 | 40 | 44 |
| Example 53 | A53 | Si | 10 | 2939 | 2720 | 92.5 | 2928 | 2586 | 88.3 | 39 | 42 |
| Example 54 | A54 | Si | 1 | 2942 | 2721 | 92.5 | 2931 | 2573 | 87.8 | 38 | 41 |
| Example 55 | A55 | Si | 0.2 | 2948 | 2731 | 92.6 | 2937 | 2521 | 85.8 | 37 | 40 |
| Comparative | X11 | Si | 0 | 2957 | 2733 | 92.4 | 2946 | 1679 | 57.0 | 36 | 39 |
| Example 11 | | | | | | | | | | | |

Each of the batteries showed excellent cycle life characteristic and high-temperature storage characteristic when the average thickness of the silicon oxide layer on the thin film surface was in the range of 0.2 to 1,000 nm. When the average thickness was 1 nm or larger, the high-temperature storage characteristic was further improved. Further, when the average thickness was 100 nm or smaller, the cycle life characteristic was more improved. These results indicated that the average thickness of the silicon oxide layer on the thin film surface was preferably 1 to 100 nm.

More preferably, the average thickness of the silicon oxide layer on the thin film surface was 1 to 10 nm. In this case, the cycle life characteristic was further improved while keeping satisfactory high-temperature storage characteristic.

As compared with the battery of Example 7 using the Si powder on which the silicon oxide surface layer having the average thickness of 100 nm was formed, the battery of Example 39 using the thin Si film having the silicon oxide surface layer of 100 nm in average thickness exhibited more excellent cycle life characteristic. Further, as compared with the battery of Example 7 using the Si powder on which the silicon oxide surface layer having the average thickness of 100 nm was formed, the battery of Example 50 using the thin Si film having the silicon oxide surface layer of 1,000 nm in average thickness exhibited more excellent cycle life characteristic.

Thus, in the case of using the thin Si film, more excellent cycle life characteristic was obtained even if the silicon oxide layer formed thereon was relatively larger in average thickness than that formed on the Si powder. It is supposed that the reason for the above-described difference in cycle life characteristic is as follows.

Through the charge/discharge of the battery, Li ions and electrons are supplied or released to and from the negative electrode. For example, if the negative electrode active material in the thin film form is adopted, the thin Si film is formed on the current collector and then heat-treated. Therefore, the silicon oxide layer is not formed between the current collector and the thin Si film. Accordingly, during the charge, the electrons are transferred from the current collector to the inner Si layer. That is, the ratio of the electrons passing through the silicon oxide layer formed on the thin film surface is small.

On the other hand, if the negative electrode active material in the powder form is adopted, each of the Si particles is covered with the silicon oxide layer. Accordingly, during the charge, the electrons are transferred from the current collector to the Si layer inside the powder via the silicon oxide layer covering the surface of the Si powder. That is, the ratio of the electrons passing through the silicon oxide layer is large. Further, due to high resistance of silicon oxide, the electron transfer is apt to be inhibited.

Thus, when the negative electrode active material in the thin film form is used, the electrons hardly pass through the silicon oxide layer during the charge and discharge. Therefore, the Li ions are smoothly absorbed and desorbed, which further inhibits an increase in reaction resistance. For the above reason, the satisfactory cycle life characteristic is obtained even if the silicon oxide layer is relatively thick, as long as the negative electrode active material in the thin film form is used.

In the above description, an explanation is given of the case where the thin film made of Si is used. However, the same effect is obtained if Sn, an alloy containing Si, or an alloy containing Sn is used as the thin film.

### EXAMPLES 56

In Examples 1-55, the surface layer comprising silicon or tin oxide formed on the negative electrode active material in the form of powder or a thin film had a thickness in the range of ±50% of the average thickness. In this example, a study was made of the case where at least one of thicknesses measured at the five random points is out of the range of ±50% of the average thickness, though the average thickness itself was the same as that of Example 40.

A thin Si film was formed in the same manner as Example 40. The thin Si film was subjected to heat treatment in an atmosphere of oxygen and Ar mixed in the volume ratio of 0.3:99.7 at 250° C. for an hour. Then, the thin Si film was partially masked and subjected to heat treatment again in an atmosphere of oxygen and Ar mixed in the volume ratio of 0.7:99.3 at 350° C. for an hour.

A battery A56 was fabricated in the same manner as Example 40 except that the thus obtained thin film was used as the negative electrode active material. The thin film and battery were evaluated in the same manner as Example 40. Table 11 shows the evaluation results together with those of Example 40.

TABLE 11

| | | | | | | | | | | Internal | |
|---|---|---|---|---|---|---|---|---|---|---|---|
| | | | Average | Discharge | | | Discharge | | | resistance | |
| | | | thickness | capacity | | | capacity | | | (mΩ) | |
| | Battery | | of surface | (mAh) | | Ratio | (mAh) | | Ratio | First | 100^{th} |
| | number | Composition | layer (nm) | C1 | C2 | P(%) | C3 | C4 | Q(%) | cycle | cycle |
| Ex. 40 | A40 | Si | 100 | 2932 | 2667 | 91.0 | 2919 | 2578 | 88.3 | 41 | 45 |
| Ex. 56 | A56 | Si | 100 | 2920 | 2578 | 88.3 | 2903 | 2498 | 86.1 | 42 | 47 |

The thicknesses of the silicon oxide layer on the thin Si film measured at the five points were 40 nm, 110 nm, 110 nm, 120 nm and 120 nm, respectively. An average of them was 100 nm. However, one of the measured thicknesses 40 nm was −60% of the average, which was out of the range of ±50%. In the battery of Example 56, an electrode reaction did not occur uniformly, thereby decreasing the cycle life characteristic and the high-temperature storage characteristic to some extent as compared with the battery of Example 40.

In Examples above, the thickness of the silicon or tin oxide layer was controlled by adjusting oxygen concentration in the atmosphere, temperature and time for the heat treatment. However, there is no limitation on how to control the thickness. For example, the alloy in the form of powder or a thin film may be immersed in an aqueous solution containing hydrofluoric acid and ammonium fluoride, dried under vacuum, as an acid treatment to remove silicon or tin oxide layer formed on the surface. Alternatively, both of the heat treatment and the acid treatment may be conducted.

Further, in Examples above, the electrolytic copper foil was used as a negative electrode current collector. However, the present invention is not limited thereto. For example, a rolled copper foil may be used. The copper foil surface may be flat or rough. Moreover, LiCoO₂ used as the positive electrode active material in Examples of the present invention may be replaced with any material as long as it is capable of reversibly charging and discharging, such as LiMn₂O₄ and LiNiO₂.

In Examples above, slurry containing a powdered negative electrode active material was applied to the electrolytic copper foil, which was dried and rolled to form the negative electrode. However, the negative electrode may be formed by other methods. For example, the powdered negative electrode active material may be sintered on the electrolytic copper foil.

The negative electrode active material of the present invention can be applied to non-aqueous electrolyte rechargeable batteries such as lithium ion rechargeable batteries in a cylindrical form, coin form, prismatic form and flat form.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode active material for a non-aqueous electrolyte rechargeable battery capable of absorbing/desorbing lithium comprising: an inner layer comprising at least a material selected from the group consisting of Si, Sn, an alloy containing Si and an alloy containing Sn; and a surface layer comprising silicon oxide or tin oxide of 0.2 to 1,000 nm in average thickness formed on said inner layer.

2. The negative electrode active material in accordance with claim 1, wherein the average thickness of said surface layer is 1 to 100 nm.

3. The negative electrode active material in accordance with claim 1, wherein the average thickness of said surface layer is 1 to 10 nm.

4. The negative electrode active material in accordance with claim 1, wherein said surface layer has a thickness in the range of ±50% of the average thickness.

5. The negative electrode active material in accordance with claim 1, wherein said alloy comprises Si or Sn and at least an element selected from the group consisting of Ti, Co, Ni, Cu, Mg, Zr, V, Mo, W, Mn and Fe.

6. The negative electrode active material in accordance with claim 1, wherein said alloy comprises at least an Si phase or an Sn phase and an alloy phase containing at least an element selected from the group consisting of Ti, Co, Ni, Cu, Mg, Zr, V, Mo, W, Mn and Fe.

7. The negative electrode active material in accordance with claim 1, which is in the form of a thin film or powder.

8. The negative electrode active material in accordance with claim 1 including an amorphous Si phase.

9. A non-aqueous electrolyte rechargeable battery using a negative electrode active material capable of absorbing/desorbing lithium comprising: an inner layer comprising at least a material selected from the group consisting of Si, Sn, an alloy containing Si and an alloy containing Sn; and a surface layer comprising silicon oxide or tin oxide of 0.2 to 1,000 nm in average thickness formed on said inner layer.
